(19) United States
(12) Patent Application Publication
(10) Pub. No.: US 2023/0269229 A1
(43) Pub. Date: Aug. 24, 2023

(54) Protecting Organizations Using Hierarchical Firewalls

(71) Applicant: Google LLC, Mountain View, CA (US)

(72) Inventors: Ujjwal Jain, San Jose, CA (US); Yuquan Jiang, San Jose, CA (US); Ines Clara Envid Lazaro, Palo Alto, CA (US); Rodney Chu, San Carlos, CA (US); Uday Ramakrishna Naik, Pleasanton, CA (US)

(21) Appl. No.: 17/679,814

(22) Filed: Feb. 24, 2022

(51) Int. Cl. H04L 9/40

(52) U.S. Cl. CPC H04L 63/0263; H04L 63/105; H04L 63/20

(57) ABSTRACT

Methods, systems, and apparatus include computer programs encoded on a computer-readable storage medium for firewall policies with improved efficiency. A policy can be defined that specifies a set of firewall rules, where the set of firewall rules provides a respective firewall rule for each layer of a plurality of layers within a hierarchical structure of a network, the network including a plurality of elements. Determining, for a first element within the network, a position within a first layer of the hierarchical structure. In response to receiving a data transmission request to or from the first element, applying the set of firewall rules in accordance with the first layer of the hierarchical structure, where applying the set of firewall rules comprises sequentially applying each respective firewall rule at each layer from an upper layer within the network to the first layer within the network.

### FIELD

The present disclosure relates generally to firewall protection. More particularly, the present disclosure relates to implementing firewall policies using a hierarchical structure.

### BACKGROUND

The Internet or other open or closed networks such as various intranets provide devices within a network access to a wide variety of resources. For example, video and/or audio files, web pages for particular subjects or particular news articles, and/or various data files or resources are accessible over the Internet. In various cases, access to these resources presents security issues that require firewall policies to be applied to those devices

A firewall policy defines how an organization's firewalls should handle inbound and outbound network traffic for specific IP addresses and/or address ranges, protocols, applications, and content types based on the organization's information security policies. Large enterprises typically have security administrators responsible for protecting these resources at various levels like at organization or department or team level. One way to protect these resources from unauthorized access is to apply firewalls at the resource level. However, this makes the administration of firewalls very difficult, as firewalls can be applied at the resource level, and there is no good way to ensure that firewall rules are specified correctly on all resources. For example, an organization level administrator may need to block traffic from a specific country, but it is challenging to ensure that all devices, such as virtual machines (VMs), in their organizations have this firewall rule applied.

Furthermore, typical approaches which define a respective firewall policy for each resource are computationally inefficient. For example, any change to a policy that affects or relates to multiple resources will require a “re-write” or other updating process to be applied to the respective firewall policy for each affected resource. These update processes require expenditure of computational resources such as processor cycles, memory usage, network bandwidth usage, etc.

What is needed is a way to apply firewall policies efficiently and in a manner in which devices have no opportunity to evade firewall policies before a security administrator can define and/or modify the firewall policies applied.

### SUMMARY

Aspects and advantages of embodiments of the present disclosure will be set forth in part in the following description, or can be learned from the description, or can be learned through practice of the embodiments.

One example aspect of the present disclosure is directed to methods, systems, and apparatus for applying firewall policies with improved efficiency. A policy can be defined that specifies a set of firewall rules, where the set of firewall rules can provide a respective firewall rule for each layer of a plurality of layers within a hierarchical structure of a network, and where the network can include a number of elements. A position can be determined for a first element within a first layer of the plurality of layers of the hierarchical structure. In response to receipt of a data transmission request to or from the first element, the set of firewall rules can be applied in accordance with the first layer of the hierarchical structure, where applying the set of firewall rules includes sequentially applying each respective firewall rule at each layer from an upper layer within the network to the first layer within the network.

Another example aspect of the present disclosure is directed to storing each respective rule for each layer is independent of the other respective rules for other layers, such that each rule is independently updatable.

Another example aspect of the present disclosure is directed to modifying the respective firewall rule associated with a second layer higher than the first layer in the hierarchical structure, which is updatable independent of the respective firewall rule associated with the first layer.

Another example aspect of the present disclosure is directed to associating a set of user access permissions with each layer of the plurality of layers, and where a user that has access permission to a particular layer is permitted to modify the respective firewall rule associated with the particular layer and any layer lower than the particular layer in the hierarchical structure but prohibited from modifying the respective firewall rule associated with any layer higher than the particular layer in the hierarchical structure.

Another example aspect of the present disclosure is directed to modifying a rule within the set of firewall rules at the upper layer, where the modification to the rule is applied to all currently associated nodes of the lower layers within the network.

Another example aspect of the present disclosure is directed to delegating a connection evaluation of a rule within the set of firewall rules to a lower level policy or to Virtual Private Cloud (VPC) network firewall rules.

Another example aspect of the present disclosure is directed to defining the set of firewall rules using one or more IP ranges to define sources for ingress rules such that administrators at any lower level cannot override the set of firewall rules.

Another example aspect of the present disclosure is directed to creating an exception to a rule within the set of firewall rules using one or more IP ranges, wherein the exception broadens a prior version of the rule.

Another example aspect of the present disclosure is directed to terminating firewall evaluation on a node within the layer of the hierarchical structure, where a lower node within any lower layer cannot override the set of firewall rules regardless of its firewall specifications, when there is a matching firewall rule to the firewall specifications of the lower node.

Another example aspect of the present disclosure is directed to enforcing the set of firewall rules at virtual machine (VM) levels.

Other aspects of the present disclosure are directed to various systems, apparatuses, non-transitory computer-readable media, user interfaces, and electronic devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 illustrates a block diagram of an example environment for implementing firewall policies with improved efficiency according to example embodiments of the present disclosure.

FIG. 2 illustrates an example flow chart diagram of an example method for implementing firewall policies with improved efficiency according to example embodiments of the present disclosure.

FIG. 3 illustrates an example flow chart diagram of an example method for delegating firewall policies within a hierarchical structure according to example embodiments of the present disclosure.

FIG. 4 illustrates a block diagram of an example environment for implementing multiple firewall policies within a hierarchical structure according to example embodiments of the present disclosure.

FIG. 5 illustrates a block diagram of an example environment for applying a firewall policy at an example layer within a hierarchical structure according to example embodiments of the present disclosure.

FIG. 6 illustrates a block diagram of an example environment for defining firewall rules within a hierarchical structure using IP ranges according to example embodiments of the present disclosure.

FIG. 7 illustrates a block diagram of an example environment for applying firewall policies to virtual machines within a hierarchical structure according to example embodiments of the present disclosure.

FIG. 8 illustrates an example user interface for defining firewall policies within a hierarchical structure according to example embodiments of the present disclosure.

FIG. 9 illustrates a block diagram of computing devices that may be used to implement the systems and methods described in this document, as either a client or as a server or plurality of servers.

Reference numerals that are repeated across plural figures are intended to identify the same features in various implementations.

### DETAILED DESCRIPTION

Generally, the present disclosure is directed to firewall protection. More particularly, the present disclosure relates to implementing firewall policies using a hierarchical structure. In particular, the proposed approaches provide a unique way to specify firewalls at each level in the hierarchy, thereby giving security administrators or other users ease of use and flexibility in protecting their network resources. For example, security administrators can apply firewalls at organization and various levels of folders. Moreover, security administrators can have control and flexibility on how to apply these firewall rules. For example, they can choose to define firewall rules in such a way that administrators at lower levels cannot override that behavior. Users may also choose to define firewall rules which delegate the behavior to lower level administrators, and administrators at lower levels can choose different behavior for their department or teams. Thus, the proposed techniques provide improved flexibility, customizability, and efficiency in network firewall policy definition and implementation.

More particularly, example systems and methods described herein allow users to organize resources within a network in hierarchical order or fashion. For example, a hierarchical structure can include a number of layers that relate to each other in a hierarchical fashion and each of a number of resources can be assigned to or associated with one of the layers in the hierarchical structure.

In embodiments, a policy can be defined that specifies one or more (e.g., a set) of firewall rules, where the set of firewall rules provides a respective firewall rule for each layer within a hierarchical structure of a network. The network can have any number of elements, and any number of layers including any number of elements. Whenever a policy is applied to a particular layer, any lower layer (and devices within each lower layer) to the particular layer are subject to the policy.

Therefore, whenever a device initiates inbound and/or outbound network traffic within the network, the organization's firewall policies can be applied immediately and without lapses to policy application at lower layers within the organization.

In contrast, in certain conventional firewall policy setups, firewall policies are applied according to a management plan, in which each policy is copied by an administrator into each separate user account. The administrator must then monitor the user account, and if there is a violation of the policy, the policy is copied again because of gaps in policy coverage. Gaps in policy coverage can happen because project owners, even if they have less security clearance than the original creator of the policy, can potentially modify the policy before it is enforced for each device.

However, with a hierarchical approach as described herein, higher level policies have no gaps in coverage—and no potential to modify firewall policies—because project owners or other administrative parties cannot access the policies applied in the hierarchy above them. This elimination of policy gap coverage increases the security of an organization. Moreover, because firewall policies are not copied for each account, less compute resources are used, making firewall policy application both speedier and more efficient.

For example, for a first device within the network, its position within the hierarchy can be determined (e.g., at a first layer). In response to receiving a data transmission request to or from the first device having the position within the first layer of the hierarchical structure, the system can apply the set of firewall rules in accordance with the first layer of the hierarchical structure. For instance, applying the set of firewall rules can include sequentially applying each respective firewall rule at each layer from an upper layer within the network to the first layer within the network.

The systems and methods of the present disclosure provide a number of technical effects and benefits. As one example, the systems and methods of the present disclosure enable the definition and implementation of firewall policies with improved efficiency. More particularly, typical approaches which define a respective firewall policy for each resource are computationally inefficient. For example, any change to a policy that affects or relates to multiple resources will require a “re-write” or other updating process to be applied to the respective firewall policy for each affected resource. These update processes require expenditure of computational resources such as processor cycles, memory usage, network bandwidth usage, etc. In contrast, by defining and applying/implementing firewall policies in a hierarchical approach as described herein, updates to a policy associated with a certain hierarchical level can automatically be applied to/evaluated for all resources within or below the certain hierarchical level, thereby obviating the need to individually maintain and update resource-specific firewall policies. Therefore, computer resources that would have previously been consumed by individually updating each resource-specific firewall policy can be conserved, resulting in a reduction of usage of computational resources.

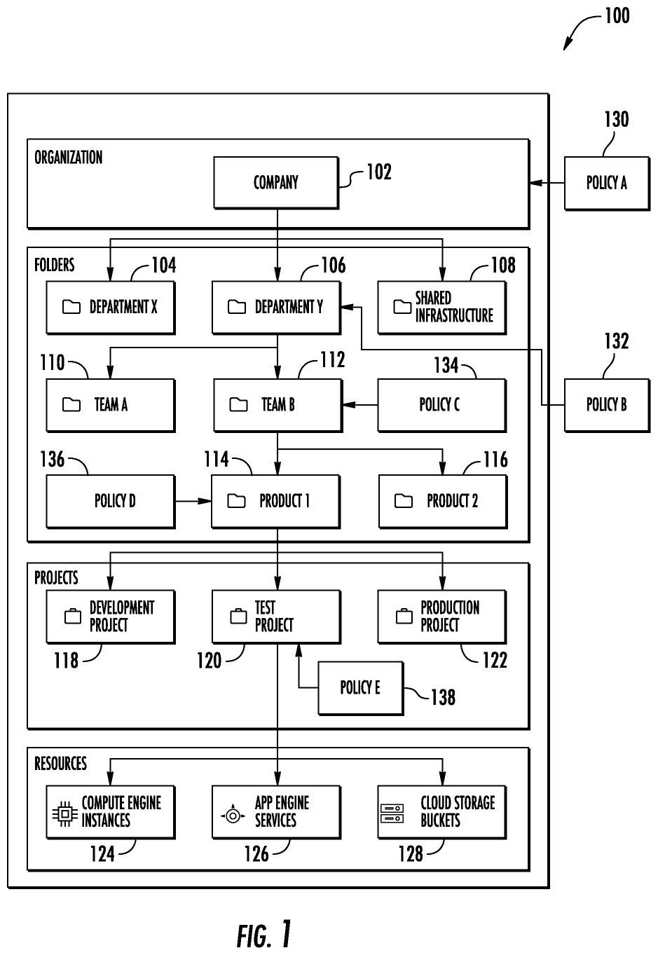

FIG. 1 illustrates a block diagram of an example environment for implementing firewall policies with improved efficiency according to example embodiments of the present disclosure. An example system 100 can include a network, such as a local area network (LAN), a wide area network (WAN), the Internet, or a combination thereof. The network connects websites, user devices, content providers, publishers, and/or content management systems. The example system 100 may include many thousands of user devices connecting to websites, content providers, and other internet resources.

A user device can be an electronic device that is under control of a user within the organization and is capable of requesting and receiving resources over the network. Example user devices include personal computers, tablet computers, mobile communication devices (e.g., smartphones), televisions, set top boxes, personal digital assistants and other devices that can send and receive data over the network. A user device can typically include one or more user applications, such as a web browser, to facilitate the sending and receiving of data over the network. The web browser can interact with various types of web applications, such as a game, a map application, or an e-mail application, to name a few examples.

In system 100, a user such as an enterprise customer can organize user devices and/or resources using a hierarchical structure. The hierarchical structure can be composed of nodes (e.g., 102, 104, 106, 108, 110, 112, 114, 116, 118, 120, 122, 124, 126, 128) with a tree structure. The hierarchical structure may further include one or more subtrees within each node. For example, node 110 and node 112 can be a subtree of node 106; node 118, node 120, and node 122 can be a subtree of node 114; node 124, node 126, and node 128 can be a subtree of node 120, etc. Nodes can be related to any type of organizational structure, such as, but not limited to: departments, projects, product areas, teams, authority levels, roles, etc. In some embodiments, nodes can be associated with and organized by folder.

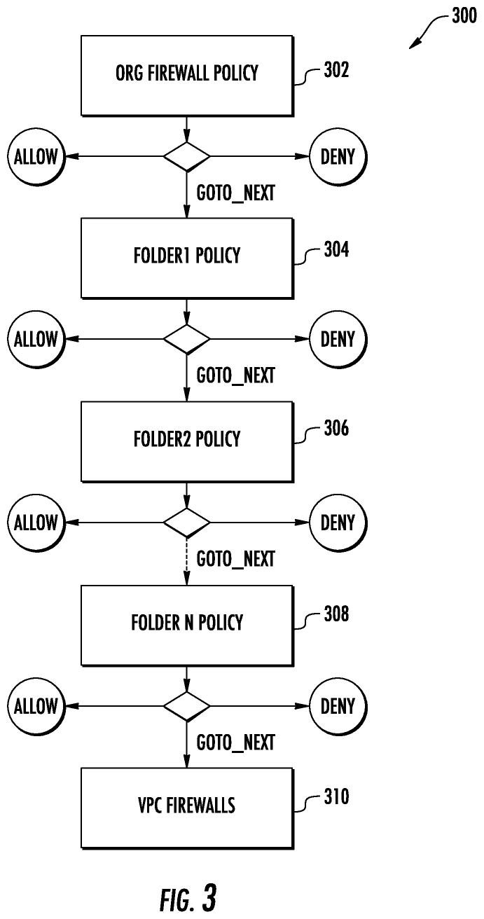

Hierarchical firewall policies can in some embodiments be assigned to the organization as a whole or to individual folders. These policies can contain rules that explicitly deny or allow connections, including non-local resources such as Virtual Private Cloud (VPC) firewall rules. In addition, hierarchical firewall policy rules can delegate evaluation to lower-level policies or VPC network firewall rules, such as with a goto_next action discussed in further detail in FIG. 3.

In some embodiments, hierarchical firewall policies can be created at organization and folder nodes. Policies, once created, can be applied to (associated with) any nodes in the organization. In some embodiments, hierarchical firewall policies can be containers for firewall rules. When a policy is associated with the organization or a folder, all rules are immediately applied. Policies can in some embodiments be swapped for a node, which automatically swaps all the firewall rules applied to virtual machine (VM) instances under that node.

For example, Policy A 130 can be a policy applied at the organization node 102. Node 102 can define a top layer for the organization, where each lower layer within the organization's hierarchical (e.g., tree) structure has Policy A 130 applied to it. In the example embodiment shown, nodes 104-128 are subject to Policy A's 130 rules. Lower-level rules—such as the rules defined by Policy B 132, Policy C 134, Policy D 136, and Policy E 138—cannot override a rule from a higher place in the resource hierarchy (e.g., Policy A 130). This lets organization-wide admins manage critical firewall rules in one place.

Similarly, Policy B 132 can define rules at one or more current and/or lower layer nodes (e.g., a first layer node 106 below the top layer) that applies to all lower layer nodes. In the example embodiment shown, node 106 (Department Y) has applied Policy B 132 to node 106, node 112, node 114, node 116, node 118, node 120, node 122, node 124, node 126, and node 128. Policy B 132 cannot override a rule, however, from Policy A 130.

Policy C 134 can define rules at one or more current and/or lower layer nodes (e.g., a second layer node 112 below the first and top layers) that applies to all lower layer nodes. In the example embodiment shown, node 112 (Team B) has applied Policy C 134 to node 112, node 114, node 116, node 118, node 120, node 122, node 124, node 126, and node 128. Policy C 134 cannot override a rule, however, from Policy A 130 or Policy B 132.

Policy D 136 can define rules at one or more current and/or lower layer nodes (e.g., a third layer node 114 below the top, first, and second layers) that applies to all lower layer nodes. In the example embodiment shown, node 114 (Product 1) has applied Policy D 136 to node 114, node 118, node 120, node 122, node 124, node 126, and node 128. Policy D 136 cannot override a rule, however, from Policy A 130, Policy B 132, or Policy C 134.

Policy E 138 can define rules at one or more current and/or lower layer nodes (e.g., a fourth layer node 106 below the top, first, second, and third layers) that applies to all lower layer nodes. In the example embodiment shown, node 120 (Test project) has applied Policy E 138 to node 120, node 124, node 126, and node 128. Policy E 138 cannot override a rule, however, from Policy A 130, Policy B 132, Policy C 134, or Policy D 136.

Rule evaluation can be hierarchical based on resource hierarchy. All rules associated with the organization node, for example, are evaluated, followed by those of the first level (e.g., first layer) of nodes/folders, and so on. This has many advantages over applying a firewall rule at the instance level using cloud network firewalls or specifying firewall rules inside of the operating system. Big enterprise customers can have hundreds and thousands of resources with security administrators at each level like at organization or department or team level. Security administrators are responsible for protecting the resources which lie in their hierarchy. For example, a security administrator at team level is responsible for resources used by that team. However, management of these firewall rules can be very difficult when there are multiple security administrators. For example, an organization level security administrator would like to “enforce” an organization level firewall rule, such as blocking traffic from certain countries in such a way that nobody below in the hierarchy can override this behavior. Because of the application of firewall rules based on hierarchy, this allows strict enforcement of firewall rules in big organizations/enterprises.

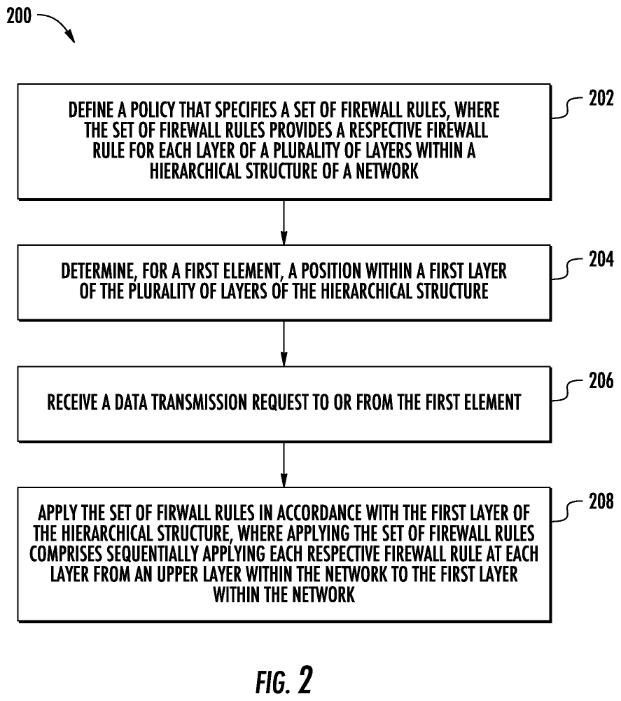

FIG. 2 illustrates an example flow chart diagram of an example method for implementing firewall policies with improved efficiency according to example embodiments of the present disclosure. Although FIG. 2 depicts steps performed in a particular order for purposes of illustration and discussion, the methods of the present disclosure are not limited to the particularly illustrated order or arrangement. The various steps of the method 200 can be omitted, rearranged, combined, and/or adapted in various ways without deviating from the scope of the present disclosure.

Method 200 allows an administrator of a network layer to define a policy that specifies a set of firewall rules, where the set of firewall rules provides a respective firewall rule for nodes at lower layers within the hierarchical structure of the network (step 202). These hierarchical firewall rules provide a unique way to specify firewalls at each level in the hierarchy, giving security administrators ease of use and flexibility in protecting their network resources. For example, security administrators can apply firewalls at organization and various levels of folders. Moreover, security administrators can have control and flexibility on how to apply these firewall rules. For example, they can choose to define firewall rules in such a way that administrators at lower levels cannot override rules defined at a higher layer. Additionally and/or alternatively, in some embodiments administrators may also choose to define firewall rules which delegates the behavior to lower layer administrators, and those administrators at lower levels can choose different behavior for their department or teams.

For an element within the network, such as a user device or other resource, a position within the network's hierarchical structure can be determined (step 204). For example, a first element can be located within a first layer of the hierarchical structure. In response to receiving a data transmission request to or from the first element having the position within the first layer of the hierarchical structure (step 206), a set of firewall rules can be applied in accordance with the first layer of the hierarchical structure (step 208). Applying the set of firewall rules can include sequentially applying each respective firewall rule at each layer from an upper layer within the network to the first layer within the network.

Some example firewall rules that can be included in a policy are, for example, allowing a prober to access all (VMs). All the virtual machine (VM) instances in an organization, for example, must be scanned and inventoried by using probes from a particular IP address (10.100.0.1) to a specific destination port (123). The organization security admin ensures that no network admins or other security admins can block that port on any VM instance in the organization. Ingress connections with source IP 10.100.0.1 and destination port 123 are allowed, as defined in the policy. Upon a match in the organization policy, the probe connections are allowed and no further rules are evaluated in the hierarchy. For any ingress connections other than from source IP 10.100.0.1 and destination port 123, there is no match; therefore, the default ingress rule in VPC firewall rules applies, denying the connection. For egress connections, there may be no match across the hierarchy-defined rules. Therefore, the default egress rule in VPC firewall rules applies, allowing egress connections.

Another example policy could be rules related to denying all external connections except to certain ports. In this use case, a firewall policy blocks all connections from external internet sources except for connections on destination ports 80, 443, and 22. An ingress internet connection on any port that is not 80, 443, and 22 is blocked no matter what the firewall rules are at the VPC network level. For any connections on port 80, 443, or 22, the policy delegates to the VPC security admin the behavior they want to enforce in their respective VPC network for those ports. For ingress connections, Ingress connections, any ingress connections from 10.0.0.0/8 match the highest priority organization-level rule delegate-internal-traffic and bypass the rest of the rules in the organization policy to be evaluated against the firewall rules configured at the VPC network level. In the VPC firewall rule, connections from 10.2.0.0/16 are allowed, and the rest of the connections are evaluated against the implied ingress rule, which is deny. Ingress connections with a source IP range that is not 10.0.0.0/8 for destination ports 22, 80, and 443 are delegated to the next level, where ports 80 and 443 are allowed, but 22 is not. All other connections are blocked. For egress connections, there is no match across the hierarchy-defined rules. Therefore, the default egress rule in VPC firewall rules applies, allowing egress connections.

Another example policy can be denying egress connections except from a specific VPC network. In this use case, the organization security admin does not allow egress connections in any VPC network, except for connections originating in the VPC network myvpc. The admin delegates the decision to open egress to public server 203.0.113.1 to the myvpc security admin. For ingress connections, there is no match across the hierarchy-defined rules. Therefore, the default ingress rule in VPC firewall rules applies, denying egress connections. All the egress connections destined to 203.0.113.1 are allowed; the rest of the connections are denied. All the egress connections destined to 203.0.113.1 match the delegate-egress-my-vpc rule and bypass the rest of the rules in the organization policy. The egress connections are then evaluated against the firewall rules configured in myvpc. The default rule allows the egress connections. The block-egress-traffic-sepc-ports rule in the organization-level policy denies the rest of the connections.

In some embodiments, administrators may also choose to define firewall rules which delegates the behavior to lower layer administrators, and those administrators at lower levels can choose different behavior for their department or teams. FIG. 3 illustrates an example flow chart diagram of an example method for delegating firewall policies within a hierarchical structure, according to example embodiments of the present disclosure. In method 300, hierarchical firewall policy rules can be deferred to a node on the next lower layer, as well as enforced at the VM level as VPC firewall rules. That is, they are not applied at the network's edge as traditional firewalls would be.

At node 302, a firewall policy can be applied organization wide. If a firewall policy is associated with the entire organization, method 300 evaluates that policy's rules applied to the VM. Each rule results in connections being allowed or denied, or the rule can instruct the firewall evaluation to go to the next level of the hierarchy, which is either a folder or a VPC network. For example, method 300 evaluates policy rules associated with each folder, starting with the top folder under the organization and working down through child folders if present. Evaluation of each rule results in connections being allowed or denied, or the rule can instruct the firewall evaluation to go to the next level of the hierarchy, which is either another folder or a VPC network. Finally, VPC firewall rules are evaluated. VPC firewall rules either allow or deny connections.

Method 300 starts from the top node 302 and collects all the nodes of the hierarchy where firewalls have been defined, and then applies them in top to down order. For example, if node 302 has a defined policy, then the rules within the policy can allow and/or deny traffic at node 302, node 304, node 306, node 308, and node 310. At node 304, if there is a defined policy, then the rules of that policy as well as the rules of node 302 can allow and/or deny traffic at node 304, node 306, node 308, and node 310. At node 306, if there is a defined policy, then the rules of that policy as well as the rules of node 302 and node 304 can allow and/or deny traffic at node 306, node 308, and node 310. At node 308, if there is a defined policy, then the rules of that policy as well as the rules of node 302, node 304, and node 306 can allow and/or deny traffic at node 310. In the example embodiment, node 310 includes VPC resources, where unless a policy is defined otherwise, has default firewall rules that deny all ingress connections and allow all egress connections.

One of the unique things about a hierarchical firewall is its capability to delegate firewall evaluation to a lower level using GOTO_NEXT rules. If a matching firewall rule allows or denies the traffic, firewall evaluation terminates on that node, and lower nodes can't override this behavior regardless of their firewall specifications. However, if the matching firewall rule has GOTO_NEXT action then firewall evaluation is moved to a lower level. For example, in the embodiment shown, node 302 can defer one or more firewall rules to node 304 via a GOTO_NEXT action. Similarly, node 304 can defer one or more firewall rules to node 306, node 306 defer one or more firewall rules to node 308, and node 308 can defer one or more firewall rules to node 310.

Therefore, a high level set of firewall rules can be defined at node 302, which are applicable to all the resources in their hierarchy. For example, security administration at organization level may decide to block internet access from certain countries. However, evaluation of firewall rules can be delegated to a lower level. For example, organization security administration can allow SSH traffic based on the team requirements and delegate specification of SSH firewall rules to security administrators of teams (e.g., node 304). Administrators of the finance department might decide to block SSH traffic, while administrators of web service might allow SSH traffic for its resources. Risky resources at the higher level can be safeguarded so that security administrators at lower levels can override those firewall rules based on one or more GOTO_NEXT actions.

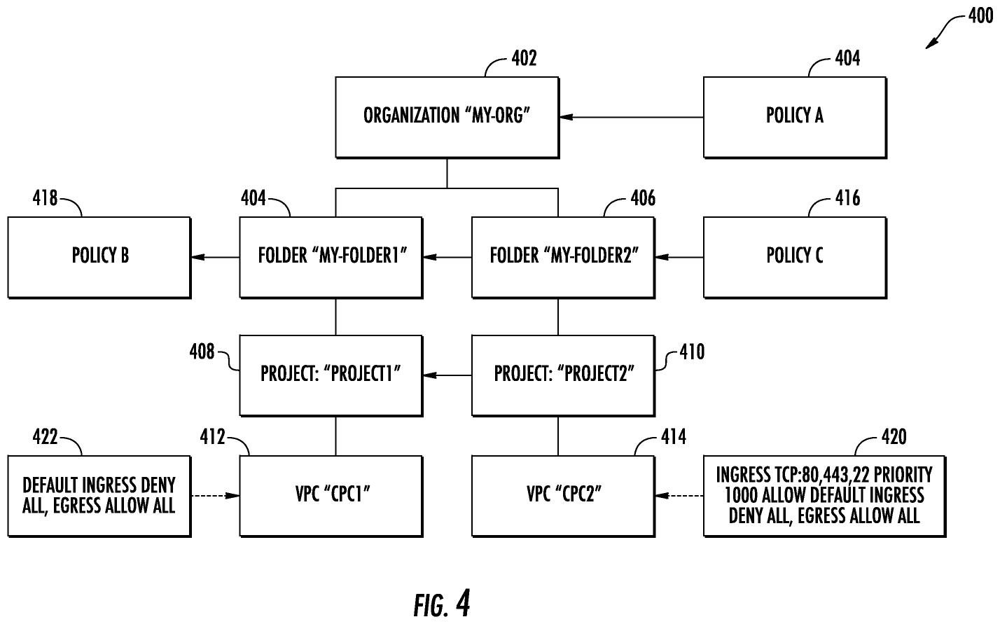

FIG. 4 illustrates a block diagram of an example environment for implementing multiple firewall policies within a hierarchical structure according to example embodiments of the present disclosure. In the example embodiment shown, node 402 of system 400 is a top layer, organization level node implementing Policy A 404. All folders and VPC networks in the organization inherit this policy, such as node 404, node 406, node 408, node 410, node 412, and node 414. For example, Policy A may define rules such as: ingress connections from 1.1.1.10/24; priority 1 go to_next Ingress; any priority 2 deny, where priority is the numeric evaluation order of the rule. The rules can be evaluated from highest to lowest priority where 0 is the highest priority. Priorities can be unique for each rule. The allowed ingress and egress connection locations can be defined.

In some embodiments, a rule within the set of firewall rules can be created and/or modified at a node belonging to a specific layer, where the modification to the rule is applied to all currently associated nodes of the lower layers within the network. The rule cannot override or contradict another rule of a rule applied by a Policy at any higher layer. For example, Policy C 416 and Policy B 418 can be applied at nodes 416 and 418, respectively, which are located at lower layers from Policy A 404 at node 402. While Policy B 418 may add rules such as: Ingress tcp: 80,443 priority 1, allow ingress any: any priority 2 deny, none of those rules can override the rules specified by Policy A 404.

Each respective rule for each layer, for example, can be stored independent of the other respective rules for other layers such that each rule is independently updatable. A modification of the respective firewall rule associated with a layer higher than the specific layer of a node in the hierarchical structure can be updatable independent of the respective firewall rule associated with the first layer. Therefore, the rules associated with a policy above the specific layer of a node does not require copying and/or updating.

To ensure that only authorized administrators of a node within a specific layer have the ability to create and/or modify policy rules, a set of user access permissions can be associated with each layer of the hierarchical network. Therefore, an administrator that has access permission to a particular layer is permitted to modify the respective firewall rule associated with the particular layer and any layer lower than the particular layer in the hierarchical structure, but is prohibited from modifying the respective firewall rule associated with any layer higher than the particular layer in the hierarchical structure. Additionally and/or alternatively, a connection evaluation of a rule within the set of firewall rules can be delegated to a lower level policy or to Virtual Private Cloud (VPC) network firewall rules. Nodes 420, 422 define default rules unless specified otherwise by an administrator in their own layer or any higher layer (in the example embodiment shown, an administrator has created Policy 420 where: Ingress tcp: 80,443,22 priority 1000 all; default Ingress deny all; egress allow all, whereas node 422 follows default rules.

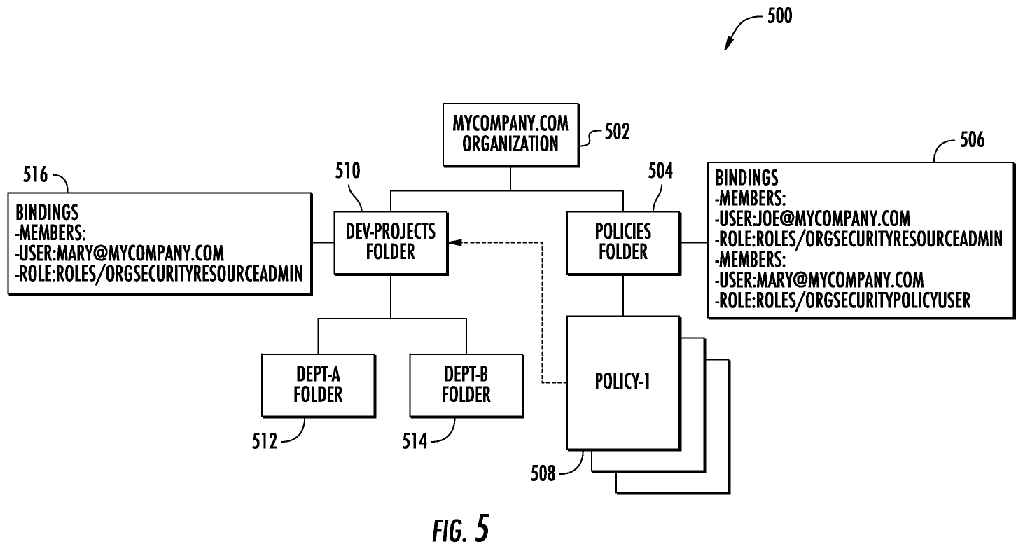

FIG. 5 illustrates a block diagram of an example environment for applying a firewall policy at an example layer within a hierarchical structure according to example embodiments of the present disclosure. For system 500, the top layer node 502 can define hierarchical firewall policy rules in a firewall policy resource that acts as a container for firewall rules. The rules defined in a firewall policy are not enforced until the policy is associated with a node (e.g., an organization or a folder). In some embodiments, such as the embodiment shown, one or more policies can be stored within a Policies Folder 504 with access permissions 506. Policy-1 508 can be one of many policies stored within Policies Folder 504.

A single policy can be associated with one or multiple nodes. If a rule is modified in a policy, that rule change applies to all currently associated nodes. For example, Policy-1 508 is associated with node 510 (“Dev-Projects Folder”). Thus, if a rule within Policy-1 508 is modified and/or created, that rule change applies to node 510, as well as any node in a lower layer within the hierarchical structure (e.g., nodes 512, 514).

In some embodiments, hierarchical firewall policy rules and VPC firewall rules are evaluated in a well-defined order (e.g., top-down order). Since user Joe is included in access permissions 506, for example, he can create, modify, and/or delete any hierarchical firewall policy in the policies folder 504, but he cannot attach the hierarchical firewall policy to a folder because he does not have the “orgSecurityResourceAdmin” role on any folder. However, because Joe granted Mary permissions to use Policy-1 508, adding her to access permissions 516, she can list and associate that hierarchical firewall policy with the Dev-Projects Folder (node 510) or any of its descendants (e.g., nodes 512, 514). The” orgFirewallPolicyUser” role does not grant permission to associate the policies to any folders; the user must also have the “orgSecurityResourceAdmin” role on the target folder.

In some embodiments, an exception to a rule can be created within the set of firewall rules using one or more IP ranges, where the exception broadens a prior version of the rule. Joe, for example, could give Mary access permissions to create exceptions for any nodes that are on a lower layer than node 510.

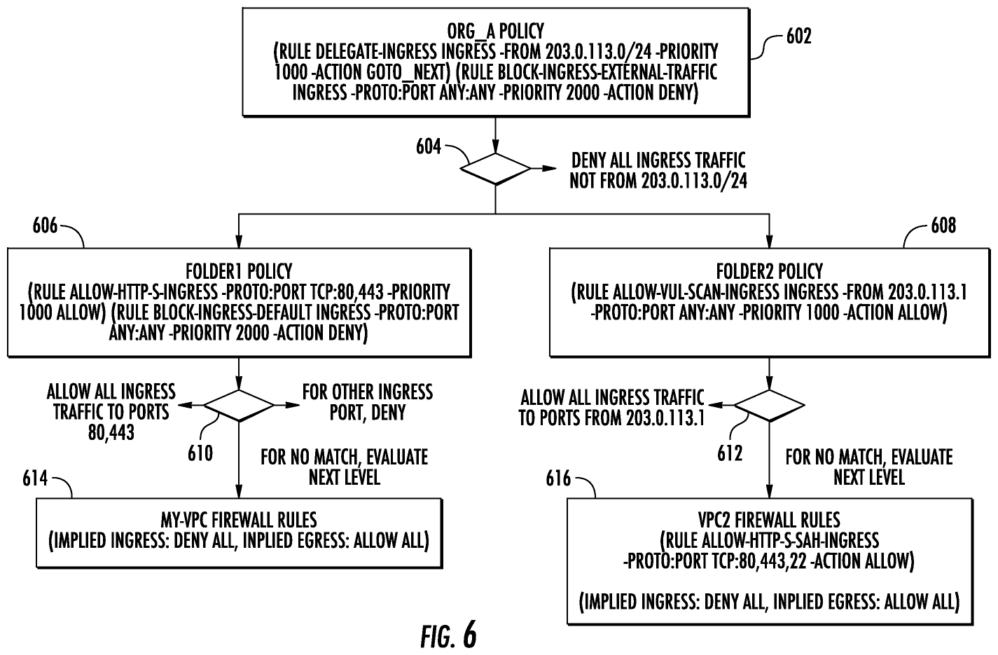

FIG. 6 illustrates a block diagram of an example environment for defining firewall rules within a hierarchical structure using IP ranges according to example embodiments of the present disclosure. The set of firewall rules within a policy can be defined, for example, using one or more IP ranges to define sources for ingress and/or egress rules such that administrators at any lower level cannot override that set of firewall rules. An example embodiment is a policy that configures organization-wide and folder-specific rules. For example, in this use case, a security administrator creates Org-A Policy 602 does not allow ingress connections (604) to any VMs in the organization except those from the allow/listed range 203.0.113.0/24. The administrator delegates further decisions about what to do with connections from 203.0.113.0/24 to security administrators at the lower folder layers.

There are two different folders at lower layers. Folder1 606 and Folder2 608. Folder1 606 has assigned a Folder1 Policy in which the policy allows connections to only ports 80 and 443 on the backend VMs, and the rest of the ports are blocked (610). Folder2 608 has assigned a Folder2 Policy in which the policy enforces that no VM in Folder2 can block any destination port for traffic from IP address 203.0.113.1. The Folder2 security administrator delegates other decisions to the VPC security admin, who decides to open ports 80, 443, and 22 and deny the rest of the ports (612).

For VMs belonging to my-vpc, all ingress connections from 203.0.113.0/24 with destination ports TCP 80 and 443 are allowed. Any other ingress connections are denied. All egress connections are accepted as per the VPC firewall rule applied due to there being no match in higher-level firewall policy rules (614).

For VMs belonging to vpc2, all ingress connections from 203.0.113.1 are allowed. Ingress connections from other 203.0.113.0/24 sources other than 203.0.113.1 are allowed only to ports 80, 443, and 22. All other ingress connections are denied. All egress connections are accepted as per the VPC firewall rule applied due to there being no match in higher-level firewall policy rules (616).

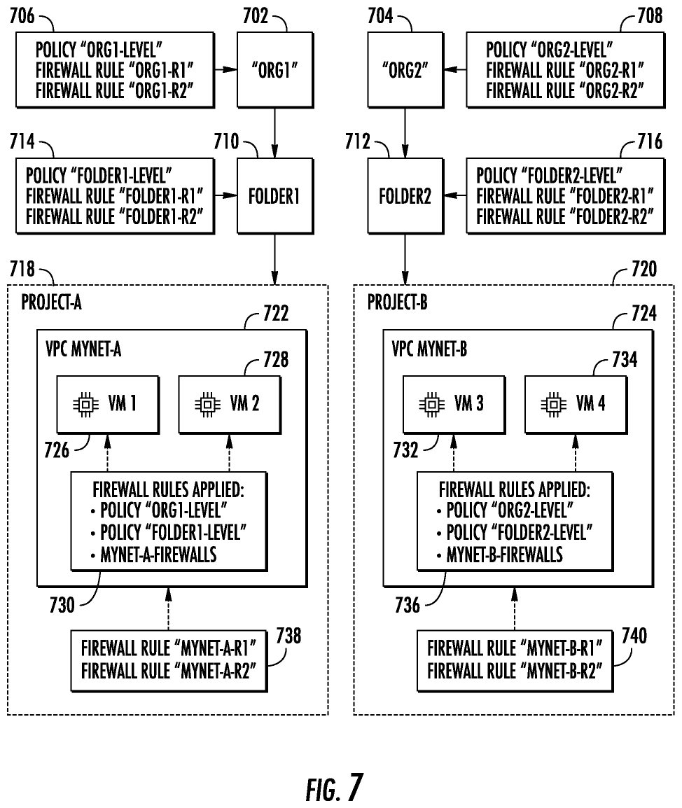

FIG. 7 illustrates a block diagram of an example environment for applying firewall policies to virtual machines within a hierarchical structure according to example embodiments of the present disclosure. In some embodiments, the set of firewall rules can be enforced at virtual machine (VM) levels. For example, in VPC Network Peering scenarios, the VM interface associated with each of the VPC networks inherits the policies in the hierarchy in the respective VPC networks. The following is a VPC Network Peering example where the VPC peered networks belong to different organizations, ORG1 702 and ORG2 704.

For example, VM1 726 and VM2 728 has firewall rules applied based on Policy 730, which includes Policy ORG1-1EVEL 706 (applied at ORG1 node 702), Policy FOLDER1-LEVEL 714 (applied at FOLDER1 710), and the MYNET-A Policy 738, which is applied to the VPC MYNET-A network 722 under Project-A 718.

Similarly, VM3 732 and VM4 734 has firewall rules applied based on Policy 736, which includes Policy ORG2-1EVEL 708 (applied at ORG2 node 704), Policy FOLDER2-LEVEL 716 (applied at FOLDER2 712), and the MYNET-B Policy 740, which is applied to the VPC MYNET-B network 724 under Project-B 720.

In embodiments, firewall evaluation can terminate on a node within its layer of the hierarchical structure, where a lower node within any lower layer cannot override the set of firewall rules regardless of its firewall specifications, when there is a matching firewall rule to the firewall specifications of the lower node. As a result, VM1 726 and VM2 728 must follow all existing rules at higher layers in the hierarchy of ORG1 702 unless a firewall rule does not have a match to any pre existing rule.

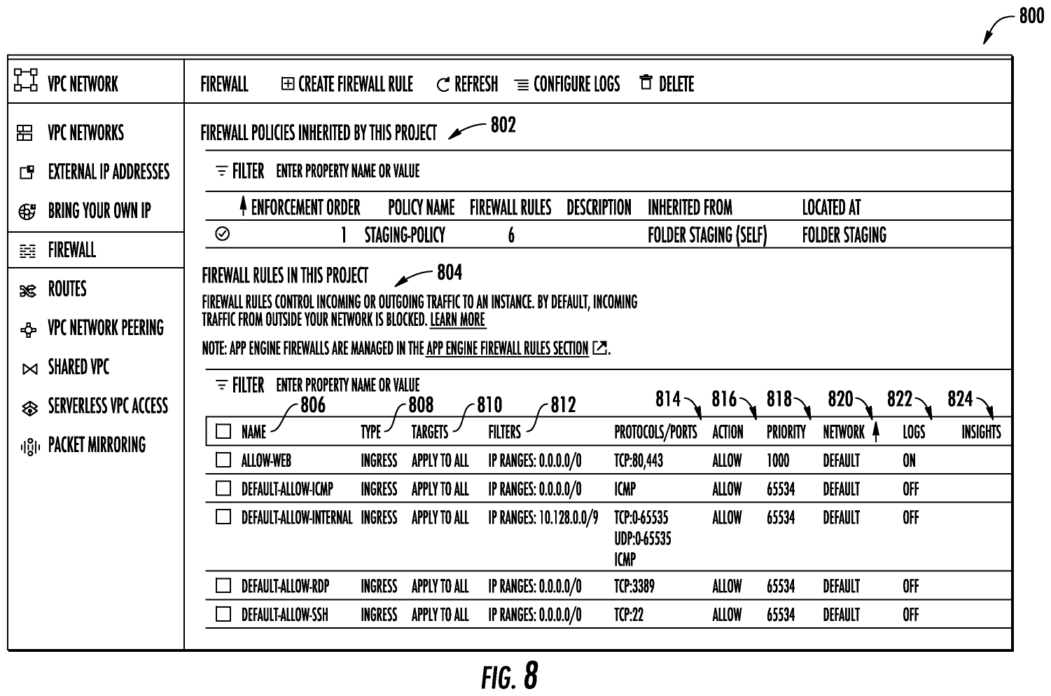

FIG. 8 illustrates an example user interface for defining firewall policies within a hierarchical structure according to example embodiments of the present disclosure. An example user interface 800 is shown, which can allow a user to view and manage firewall policies. The user interface 800 includes row 802, which shows policies inherited by the node (if there is permission granted to see that information). Row 804 allows a user to manage, create, delete, and/or modify the firewall rules within the project that will be applied to the policy for the project node. Rules are listed with columns corresponding to the rule name 806, type of rule 808 (ingress vs egress traffic), targets 810, filters 812 (specifying IP ranges, for example), protocols/ports 814, action 816 (e.g., allow, deny, or go_to next), priority 818, network setting 820, logs 822 (OFF or ON), and/or insights 824 related to the firewall rule.

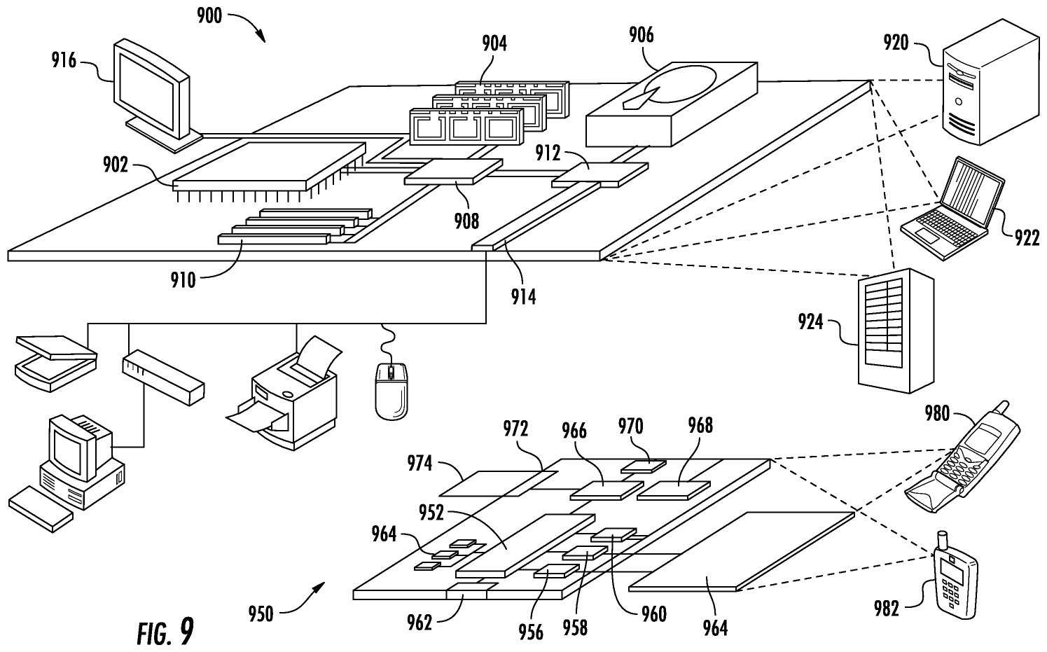

FIG. 9 illustrates a block diagram of computing devices 900, 950 that may be used to implement the systems and methods described in FIGS. 1-8 of this document, as either a client or as a server or plurality of servers. Computing device 900 is intended to represent various forms of compute resources or elements within one or more networks, such as digital computers like laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure covers such alterations, variations, and equivalents.

Computing device 900 includes a processor 902, memory 904, a storage device 906, a high-speed interface 908 connecting to memory 904 and high-speed expansion ports 910, and a low-speed interface 912 connecting to low-speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a computer-readable medium. The computer-readable medium is not a propagating signal. In one implementation, the memory 904 is a volatile memory unit or units. In another implementation, the memory 904 is a non-volatile memory unit or units.

The storage device 906 is capable of providing mass storage for the computing device 900. In one implementation, the storage device 906 is a computer-readable medium. In various different implementations, the storage device 906 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 904, the storage device 906, or memory on processor 902.

The high-speed controller 908 manages bandwidth intensive operations for the computing device 900, while the low-speed controller 912 manages lower bandwidth-intensive operations. Such allocation of duties is illustrative only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can process instructions for execution within the computing device 950, including instructions stored in the memory 964. The processor may also include separate analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT LCD display or an OLED display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provided in communication with processor 952, so as to enable near area communication of device 950 with other devices. External interface 962 may provide, for example, for wired communication (e.g., via a docking procedure) or for wireless communication (e.g., via Bluetooth or other such technologies).

The memory 964 stores information within the computing device 950. In one implementation, the memory 964 is a computer-readable medium. In one implementation, the memory 964 is a volatile memory unit or units. In another implementation, the memory 964 is a non-volatile memory unit or units. Expansion memory 974 may also be provided and connected to device 950 through expansion interface 972, which may include, for example, a SIMM card interface. Such expansion memory 974 may provide extra storage space for device 950 or may also store applications or other information for device 950. Specifically, expansion memory 974 may include instructions to carry out or supplement the processes described above and may include secure information also. Thus, for example, expansion memory 974 may be provided as a security module for device 950 and may be programmed with instructions that permit secure use of device 950. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS receiver module 970 may provide additional wireless data to device 950, which may be used as appropriate by applications running on device 950.

Device 950 may also communicate audibly using audio codec 960, which may receive spoken information from a user and convert it to usable digital information. Audio codex 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interactions with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that include a front-end component (e.g., a client computer having a graphical user interface or a Web browser through which a user can interact with an implementation of the systems and techniques described here), or any combination of such backend, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the systems and methods have been described, it should be recognized that numerous other applications are contemplated. Accordingly, other embodiments are within the scope of the following claims.

What is claimed is:

1. A computer-implemented method for firewall policies with improved efficiency, the method comprising:
defining a policy that specifies a set of firewall rules, wherein the set of firewall rules provides a respective firewall rule for each layer of a plurality of layers within a hierarchical structure of a network, the network comprising a plurality of elements;
determining, for a first element of the plurality of elements within the network, a position within a first layer of plurality of layers of the hierarchical structure;
receiving a data transmission request to or from the first element having the position within the first layer of the hierarchical structure; and
in response to receipt of the data transmission request, applying the set of firewall rules in accordance with the first layer of the hierarchical structure, wherein applying the set of firewall rules comprises sequentially applying each respective firewall rule at each layer from an upper layer within the network to the first layer within the network.

2. The method of claim 1, wherein each respective rule for each layer is stored independent of the other respective rules for other layers such that each rule is independently updatable.

3. The method of claim 1, wherein a modification of the respective firewall rule associated with a second layer higher than the first layer in the hierarchical structure is updatable independent of the respective firewall rule associated with the first layer.

4. The method of claim 1, wherein a set of user access permissions is associated with each layer of the plurality of layers, and wherein a user that has access permission to a particular layer is permitted to modify the respective firewall rule associated with the particular layer and any layer lower than the particular layer in the hierarchical structure but prohibited from modifying the respective firewall rule associated with any layer higher than the particular layer in the hierarchical structure.

5. The method of claim 1, the method further comprising:
modifying a rule within the set of firewall rules at the upper layer, wherein the modification to the rule is applied to all currently associated nodes of the lower layers within the network.

6. The method of claim 1, the method further comprising:
delegating a connection evaluation of a rule within the set of firewall rules to a lower level policy or to Virtual Private Cloud (VPC) network firewall rules.

7. The method of claim 1, the method further comprising:
defining the set of firewall rules using one or more IP ranges to define sources for ingress rules such that administrators at any lower level cannot override the set of firewall rules.

8. The method of claim 1, the method further comprising:
creating an exception to a rule within the set of firewall rules using one or more IP ranges, wherein the exception broadens a prior version of the rule.

9. The method of claim 1, wherein defining the policy further comprises:
terminating firewall evaluation on a node within the layer of the hierarchical structure, wherein a lower node within any lower layer cannot override the set of firewall rules regardless of its firewall specifications, when there is a matching firewall rule to the firewall specifications of the lower node.

10. The method of claim 1, wherein the set of firewall rules are enforced at virtual machine (VM) levels.

11. A system for firewall policies with improved efficiency comprising:
one or more processors; and
one or more memory elements including instructions that when executed cause the one or more processors to:
define a policy that specifies a set of firewall rules, wherein the set of firewall rules provides a respective firewall rule for each layer of a plurality of layers within a hierarchical structure of a network, the network comprising a plurality of elements;
determine, for a first element of the plurality of elements within the network, a position within a first layer of plurality of layers of the hierarchical structure;
receive a data transmission request to or from the first element having the position within the first layer of the hierarchical structure; and
in response to receipt of the data transmission request, apply the set of firewall rules in accordance with the first layer of the hierarchical structure, wherein applying the set of firewall rules comprises sequentially applying each respective firewall rule at each layer from an upper layer within the network to the first layer within the network.

12. The system of claim 11, wherein each respective rule for each layer is stored independent of the other respective rules for other layers such that each rule is independently updatable.

13. The system of claim 11, wherein a modification of the respective firewall rule associated with a second layer higher than the first layer in the hierarchical structure is updatable independent of the respective firewall rule associated with the first layer.

14. The system of claim 11, wherein a set of user access permissions is associated with each layer of the plurality of layers, and wherein a user that has access permission to a particular layer is permitted to modify the respective firewall rule associated with the particular layer and any layer lower than the particular layer in the hierarchical structure but prohibited from modifying the respective firewall rule associated with any layer higher than the particular layer in the hierarchical structure.

15. The system of claim 11, the instructions that when executed cause the one or more processors to further:
modify a rule within the set of firewall rules at the upper layer, wherein the modification to the rule is applied to all currently associated nodes of the lower layers within the network.

16. The system of claim 11, the instructions that when executed cause the one or more processors to further:
delegate a connection evaluation of a rule within the set of firewall rules to a lower level policy or to Virtual Private Cloud (VPC) network firewall rules.

17. The system of claim 11, the instructions that when executed cause the one or more processors to further:
define the set of firewall rules using one or more IP ranges to define sources for ingress rules such that administrators at any lower level cannot override the set of firewall rules.

18. A non-transitory computer readable medium embodied in a computer-readable storage device and comprising instructions for firewall policies with improved efficiency that, when executed by a processor, cause the processor to:
define a policy that specifies a set of firewall rules, wherein the set of firewall rules provides a respective firewall rule for each layer of a plurality of layers within a hierarchical structure of a network, the network comprising a plurality of elements;
determine, for a first element of the plurality of elements within the network, a position within a first layer of plurality of layers of the hierarchical structure;
receive a data transmission request to or from the first element having the position within the first layer of the hierarchical structure; and
in response to receipt of the data transmission request, apply the set of firewall rules in accordance with the first layer of the hierarchical structure, wherein applying the set of firewall rules comprises sequentially applying each respective firewall rule at each layer from an upper layer within the network to the first layer within the network.

19. The non-transitory computer readable medium of claim 18, wherein each respective rule for each layer is stored independent of the other respective rules for other layers such that each rule is independently updatable.

20. The non-transitory computer readable medium of claim 18, wherein a modification of the respective firewall rule associated with a second layer higher than the first layer in the hierarchical structure is updatable independent of the respective firewall rule associated with the first layer.
